(19) United States
(12) Patent Application Publication
(10) Pub. No.: US 2012/0038283 A1
(43) Pub. Date: Feb. 16, 2012

(54) LIGHT EMITTING DIODE DRIVING SYSTEM AND CIRCUIT THEREOF

(75) Inventors: HSIANG LIN HSU, TAOYUAN COUNTY 325 (TW); EN LIANG SHEN, YUNLIN COUNTY 630 (TW); CHIH CHE SHEN, HSINCHU COUNTY 303 (TW)

(73) Assignee: STARCHIPS TECHNOLOGY INC., HSIN-CHU (TW)

(21) Appl. No.: 13/207,785

(22) Filed: Aug. 11, 2011

(30) Foreign Application Priority Data
Aug. 13, 2010 (TW) 099127042

(51) Int. Cl. H05B 37/02

(52) U.S. Cl. 315/161

(57) ABSTRACT

The present invention relates to a light emitting diode (LED) driving system and a circuit thereof. The LED driving circuit is configured to control a direct voltage converter configured to generate a regulated output voltage to an input terminal of an LED array. The LED array has a plurality of LED sets. The LED driving circuit includes a plurality of current sources, a comparison circuit and a current setup circuit. The plurality of current sources are connected to a plurality of output terminals of the LED array, and are configured to provide a current flowing through the plurality of LED sets. The comparison circuit is connected to a plurality of output terminals of the LED array, and is configured to generate an analog or digital feedback signal representing a status of the supply voltage for the LED array. The current setup circuit is configured to set up the initial current value of the current sources. The direct voltage converter regulates is the output voltage by taking into consideration the feedback signal.

### BACKGROUND OF THE INVENTION

1. Field of the Invention

The current disclosure relates to a light emitting diode (LED) driving system and circuit thereof.

2. Description of the Related Art

Liquid Crystal Display (LCD) is widely applied on current electronic products such as TVs, monitors, notebooks, mobile phones and PDAs. Therefore, the demand for backlight modules is growing. Since LEDs have such advantages as low power consumption, high brightness, small size and long life, most backlight modules of LCD use LEDs as the light source.

When applied on a backlight module, the LEDs are usually present as a set of serially connected LEDs which is called an LED chain, LED set or is LED bank. An LED circuit is usually used to provide fixed currents to many LED sets in order to turn on the LED sets and keep their brightness uniform.

A general DC-DC converter takes resistor to divide voltage to generate an analog feedback signal in order to create a fixed supply voltage applied on a plurality of LED sets and a driving circuit. If the supply voltage is larger than the needed voltage of the driving circuit and the plurality of LED sets, the driving circuit will consume the extra supply voltage and generate heat loss. In contrast, if the fixed voltage is smaller than the needed voltage of the driving circuit and the plurality of LED sets, the plurality of LED sets will lack brightness and have function disability.

Therefore, in order to decrease unnecessary heat loss of the driving circuit and provide enough supply voltage to drive a plurality of LED sets connected to the driving circuit, it is necessary to provide an LED array driving system that solves the aforementioned problems.

### SUMMARY OF THE INVENTION

In accordance with one embodiment of the present invention, a light emitting diode (LED) driving circuit for controlling a direct current (DC) voltage converter to apply a regulated output voltage to an input terminal of an LED array having a plurality of LED sets, the LED driving circuit comprising a plurality of current sources connected to a plurality of output terminals of the LED array and configured to provide a current flowing through the plurality of LED sets, a comparison circuit connected to the plurality of output terminals and configured to generate a feedback signal representing the status of the LED array, and a current setup circuit configured to set the initial current value of the plurality of current sources, is wherein the DC voltage converter is configured to generate the regulated output voltage by taking into consideration the feedback signal.

In accordance with one embodiment of the present invention, a driving system for driving an LED array having a plurality of LED sets is configured to generate an regulated output voltage to an input terminal of the LED array, the driving system comprising an LED driving circuit which comprises a plurality of current sources connected to a plurality of output terminals of the LED array and configured to provide a current flowing through the plurality of LED sets, a comparison circuit connected to the plurality of output terminals and configured to generate a feedback signal representing a status of the LED array, and a DC voltage converting unit configured to generate the regulated output voltage of the driving system by taking into consideration the feedback signal.

In accordance with one embodiment of the present invention, an LED driving system for controlling a DC voltage converter to apply a regulated output voltage to an input terminal of an LED array having a plurality of LED sets, wherein the LED driving system comprises a first LED driving circuit connected to the DC voltage converter and at least one second LED driving circuit connected in series to the first LED driving circuit, and each of the first and second LED driving circuits comprises a plurality of current sources connected to a plurality of output terminals of a corresponding LED sets of the LED driving array and configured to provide a current flowing through the corresponding LED sets, a comparison circuit module connected to the plurality of output terminals of the corresponding LED sets of the LED driving array and an output terminal of a previous stage and configured to generate a feedback signal representing a status of the LED array, and a current setup circuit configured to set an initial current value flowing through the plurality of corresponding LED sets, wherein the DC voltage converter is configured to generate the regulated output voltage by taking into consideration the feedback signal of the first LED driving circuit.

In accordance with one embodiment of the present invention, an LED driving system for generating a regulated output voltage to an input terminal of an LED array having a plurality of LED sets, wherein the LED driving system comprises a DC voltage converting unit, a first LED driving circuit connected to the DC voltage converting unit and at least one second LED driving circuits connected in series to the first LED driving circuit, wherein each of the first and second LED driving circuits comprises a plurality of current sources connected to a plurality of output terminals of a corresponding LED sets of the LED driving array and configured to provide a current flowing through the corresponding LED sets, a comparison circuit module connected to the plurality of output terminals of the corresponding LED sets of the LED driving array and an output terminal of a previous stage and configured to generate a feedback signal representing the status of the LED array, and a current setup circuit configured to set an initial current value flowing through the plurality of corresponding LED sets, wherein the DC voltage converter is to regulate its output voltage by taking into consideration the feedback signal of the first LED driving circuit.

In order to better understand the techniques, means, and effects of the current disclosure, the following detailed description and drawings are provided so that the purposes, features and aspects of the current disclosure can be thoroughly and concretely appreciated; however, the drawings are provided solely for reference and illustration and are not to be used to limit the current disclosure.

### BRIEF DESCRIPTION OF THE DRAWINGS

The objectives and advantages of the present invention are illustrated in the following descriptions and with reference to the accompanying drawings in which:

FIG. 1 schematically illustrates one embodiment of the present invention with an LED driving circuit having a DC voltage converter;

FIG. 2 shows one embodiment of the present invention with circuit blocks of the DC voltage converter and the LED driving circuit;

FIG. 3 shows one embodiment of the present invention with circuit blocks of the DC voltage converter and the LED driving circuit;

FIG. 4 schematically illustrates one embodiment of the present invention with the structure of the LED driving system;

FIG. 5 shows circuit blocks of the LED driving system;

FIG. 6 shows another embodiment of the present invention with circuit blocks of the LED driving system;

FIG. 7 schematically illustrates one embodiment of the present invention with the LED driving system;

FIG. 8 shows circuit blocks of the LED driving circuit;

FIG. 9 shows circuit blocks of the comparison circuit module;

FIG. 10 schematically illustrates another embodiment of the present invention with LED driving system;

FIG. 11 shows circuit blocks of the LED driving circuit; and

FIG. 12 schematically illustrates another embodiment of the present invention with the LED driving system.

### DETAILED DESCRIPTION OF THE INVENTION

The present invention discloses an LED driving system and circuit thereof.

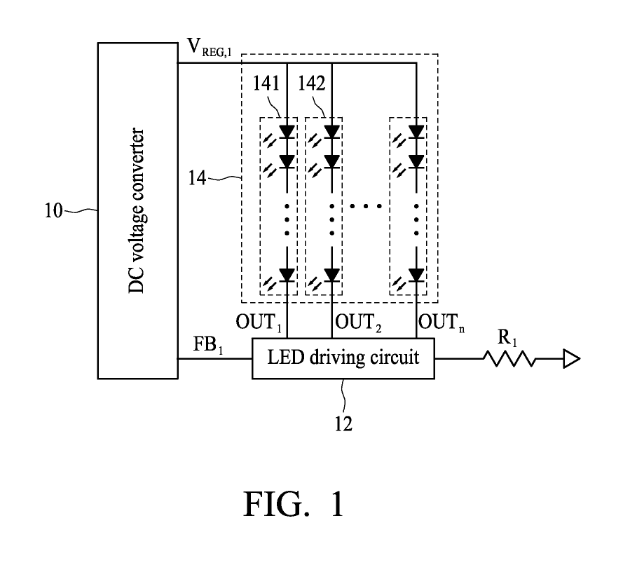

FIG. 1 schematically illustrates one embodiment of the present invention with an LED driving circuit 12 having a DC voltage converter. The LED driving circuit 12 is for controlling the DC voltage converter 10 to generate a regulated DC output voltage V_{REG, 1} to an input terminal of an LED array 14. In current embodiment, the DC voltage converter 10 is a switch type voltage stabilizer and configured to generate a higher output voltage from an input power, such as a battery, to offer the LED array 14. As shown in FIG. 1, the LED array 14 has a plurality of LED sets 141 and 142, wherein each of the plurality of LED sets has a plurality of LED connected in series. The LED driving circuit 12 is configured to provide a plurality of fixed current sources (not shown) to the corresponding LED sets.

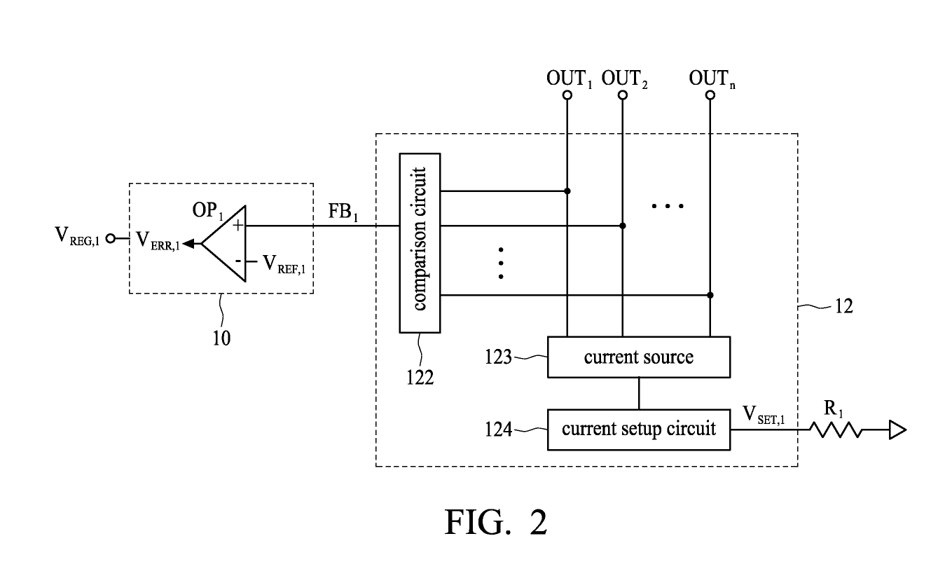

FIG. 2 shows one embodiment of the present invention with circuit blocks of the DC voltage converter and the LED driving circuit. As shown in FIG. 2, the LED driving circuit 12 comprises a comparison circuit 122 and a current setup circuit 124. The comparison circuit 122 is connected to a plurality of output terminals OUT₁-OUTₙ of the LED array 14 and is configured to generate a feedback signal FB 1 representing a status of the LED array 14. In accordance with one embodiment of the current invention, the comparison circuit 122 is a voltage comparator which is used to compare voltages of the plurality of output terminals OUT₁-OUTₙ. When a voltage value of the output terminal OUT₁ is a minimum, the feedback signal FB₁ is the voltage value of the output terminal OUT₁. In accordance with another embodiment of the current invention, the comparison circuit 122 is a current comparator which is used to compare currents flowing through each of the plurality of LED sets. When a current of the LED set 141 is a minimum, the feedback signal FB₁ is a voltage value of the output terminal OUT₁ of the LED set 141. The current setup circuit 124 is configured to set a current value of the plurality of a fixed current source 123. In the present embodiment, the current setup circuit 124 is configured to set the current value of the current source 123 by a resistor R₁.

In operation, the LED connected in series of the plurality of LED sets, each has a slightly different voltage drop V_{F} so that the plurality of output terminals OUT₁-OUTₙ of the LED array 14 also each have a different voltage. If the DC voltage V_{REG, 1} from the DC voltage converter 10 is not is able to be regulated with total voltage drop of the plurality of LED sets, the extra voltage of the DC voltage V_{REG, 1} will be consumed by the driving circuit 12, and causes power loss of the driving circuit. If the DC voltage V_{REG, 1} is insufficient, this will cause lack of brightness of the LED array 14 and even function disability of some of the plurality of LED sets.

Therefore, in accordance with one embodiment of the present invention, the feedback signal FB₁ is a minimum voltage of the plurality of output terminals OUT₁-OUTₙ of the LED array 14, or the feedback signal FB₁ is a voltage value of one of the plurality of LED sets having a minimum current value of the LED array 14. As shown in FIG. 2, the feedback signal FB₁ is transmitted to an input terminal of an error amplifier inside the DC voltage converter 10. The error amplifier OP₁ is configured to amplify a voltage signal, and a voltage difference between the feedback signal FB₁ and a reference voltage V_{REF, 1} built-in the DC voltage converter 10, to generate an output signal V_{ERR, 1}. Thus, by taking into consideration the output signal V_{ERR, 1}, the output voltage V_{REG, 1} of the DC voltage converter 10 can be configured to generate a proper voltage to the LED driving circuit 12.

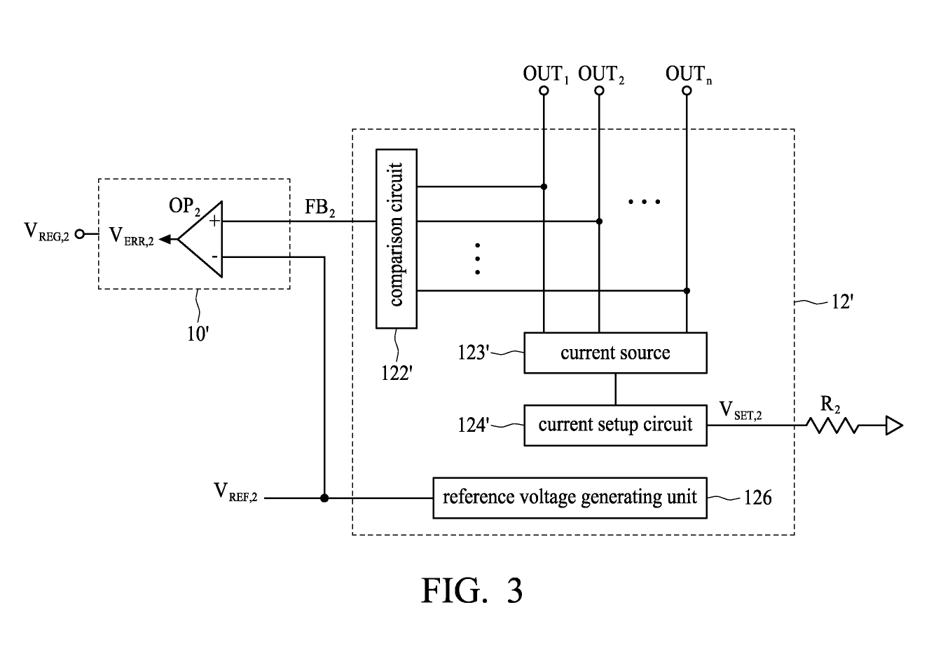

Moreover, the DC voltage converter can be configured to receive an external voltage which is set up by users, and the DC voltage converter is configured to generate a regulated output voltage by taking into consideration a difference between the feedback signal and the external reference voltage. FIG. 3 shows one embodiment of the present invention with circuit blocks of the DC voltage converter and the LED driving circuit. As shown in FIG. 3, the LED driving circuit can have a reference voltage generating unit 126. The reference voltage generating unit 126 is configured to generate a reference voltage V_{REF, 2} to the DC voltage converter 10′. In one embodiment, the reference voltage V_{REF, 2} and the voltage V_{SET, 2} of the resistor R₂ are equal or proportional to each other, which means the reference voltage V_{REF, 2} is regulated with different currents flowing through the plurality of LED sets.

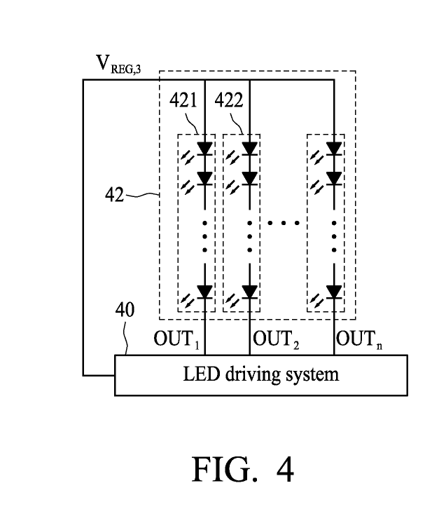

FIG. 4 schematically illustrates one embodiment of the present is invention with the structure of the LED driving system 40. The driving system 40 is for driving an LED array 42. As shown in FIG. 4, the LED array 42 has a plurality of LED sets 421 and 422, wherein each of the plurality of LED sets has a plurality of LED connected in series. The LED driving system 40 is configured to generate an regulated output voltage V_{REG, 3} to an input terminal of the LED array 42, and generate a plurality of fixed current sources (not shown) to the corresponding LED sets.

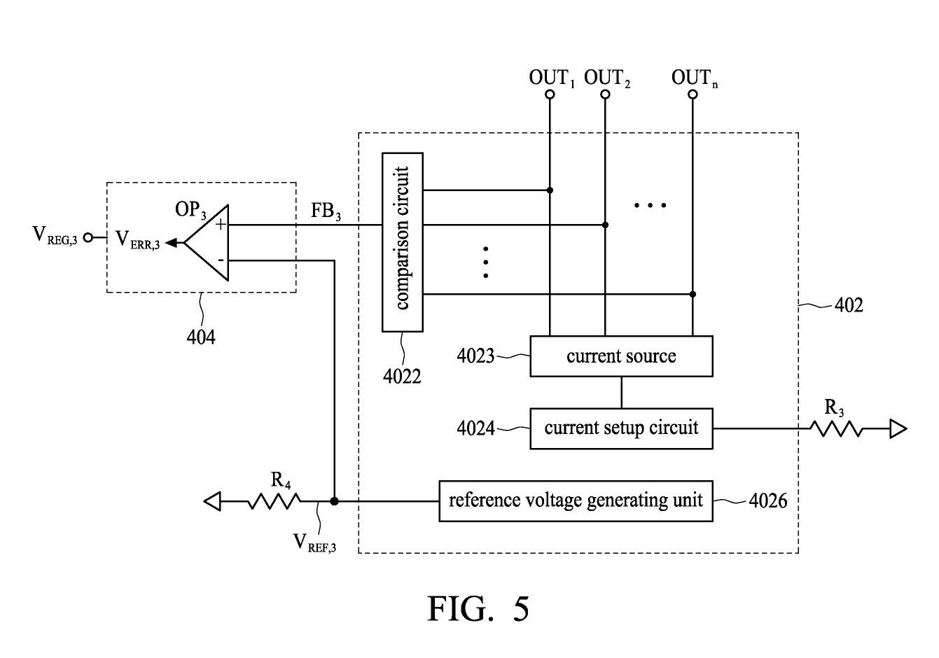

FIG. 5 shows circuit blocks of the LED driving system 40. The driving system 40 has an LED driving circuit 402 and a DC voltage converting unit 404. As shown in FIG. 5, the LED driving circuit 402 has a comparison circuit 4022 and a current setup circuit 4024. The comparison circuit 4022 connected to the plurality of output terminals OUT₁-OUTₙ of the LED array 42 is configured to generate a feedback signal FB₃ representing a status of LED array 42.

The DC voltage converting unit 404 can be configured to receive an external reference voltage V_{REF, 3} which is set up by users, and the DC voltage converter is configured to generate a regulated output voltage V_{REG, 3} by taking into consideration a voltage difference between the feedback signal FB3 and the external reference voltage. In another one embodiment, as shown in FIG. 5, the LED driving circuit has a reference voltage generating unit 4026. The reference voltage generating unit 4026 is configured to generate the reference voltage V_{REF, 3} to the DC voltage converting unit 404. In another embodiment, the reference voltage V_{REF, 3} is a fixed value. In another embodiment, the value of the reference voltage V_{REF, 3} can be set up by a resistor R4 having a same resistance as the resistor R₃. The resistor R₃ is used to set up current flowing through the plurality of LED sets. The reference voltage V_{REF, 3} can be regulated with different currents flowing through the plurality of LED sets.

Similarly, the comparison circuit 4022 of the LED driving system 40 can be a voltage comparator which is configured to compare voltages of the plurality of output terminals OUT₁-OUTₙ of the LED array 42. The is comparison circuit 4022 can also be a current comparator configured to compare a current value flowing through each of the LED sets. Therefore, the feedback signal FB₃ can be a minimum of voltages of the plurality of output terminals of the LED array 42, or the feedback signal FB₃ can be a voltage value of the output terminal of the LED set having a minimum current value of the LED array 42. Moreover, with the feedback signal FB₃ and the reference voltage V_{REF, 3}, the LED driving system 40 is configured to generate a regulated output voltage V_{REG, 3} by taking into consideration the total voltage drop V_{F} of the plurality of LED sets.

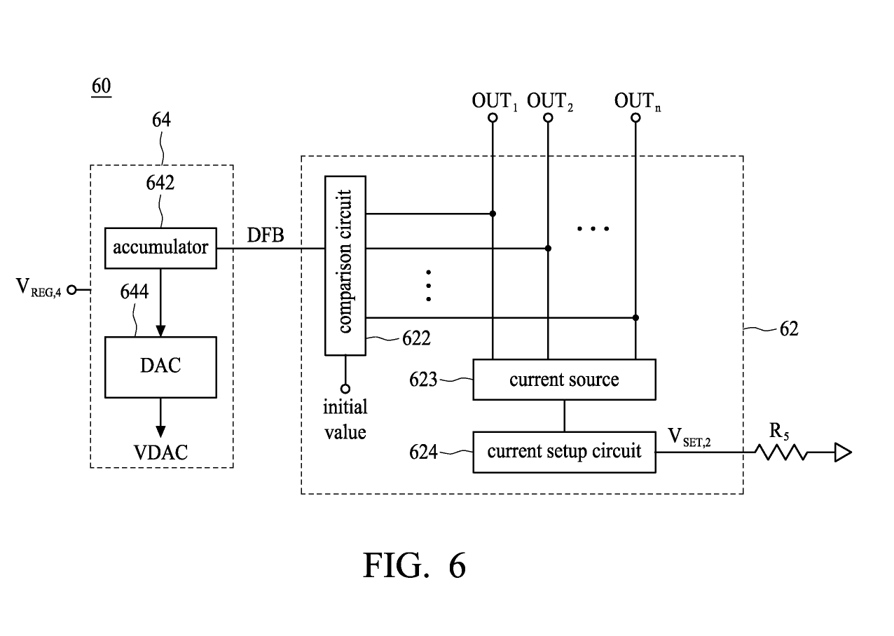

FIG. 6 shows another embodiment of the present invention indicating circuit blocks of the LED driving system 60. The driving system 60 includes an LED driving circuit 62 and a DC voltage converting unit 64. As shown in FIG. 6, the LED driving circuit 62 includes a comparison circuit 622 and a current setup circuit 624. The comparison circuit 622 is configured to generate a feedback signal DFB representing a status of the LED array and the feedback signal DFB is a digital signal. The current setup circuit 624 is configured to set up a current value flowing through an LED array.

In accordance with one embodiment of the current invention, the comparison circuit 622 is a voltage comparator configured to compare a first initial value and voltages of the plurality of output terminals of an LED array. When any one of the voltage values of the plurality of output terminals is smaller than the first initial value, the feedback signal DFB stays on logic signal level 0. When voltage values of all of the plurality of output terminals are larger than the first initial value, the feedback signal DFB will change to output logic signal level 1.

In accordance with another embodiment of the current invention, the comparison circuit 622 is a current comparator configured to compare a second initial value and currents flowing through each of the plurality of LED sets. When any one of the current values flowing through the plurality of LED sets is smaller than the second initial value, the feedback signal is DFB stays on logic signal level 0. When the current values of all of the plurality of output terminals are larger than the second initial value, the feedback signal DFB will toggle to output logic signal level 1.

As shown in FIG. 6, the DC voltage converting unit 64 includes an accumulator 642 and a DAC 644 connected to the accumulator 642. When logic output of the comparison circuit 622 stays on logic signal level 0, the accumulator 642 will count one at each time interval. This means the output signal of the accumulator 642 represents the time of the comparison circuit 622 staying on logical signal level 0. The DAC 644 is configured to convert an output signal of the accumulator 642 to an analog signal VDAC. The output voltage V_{REG, 4} of the LED driving system 60 will be regulated by taking into consideration the analog signal VDAC.

In operation, when any one of voltage values of the plurality of output terminals of the LED array is smaller than the first initial value, or when any one of currents flowing through the plurality of LED sets is smaller than the second initial value, the corresponding LED set will have lack brightness or have function disability. Furthermore, the accumulator starts counting when the feedback signal DFB is at logic signal level 0. The DAC 644 converts an output value of the accumulator 642 to an analog signal VDAC to increase the output voltage V_{REG, 4} of the LED driving system 60. After a time interval, when any one of voltage values of the plurality of output terminals of the LED array is still smaller than the first initial value, or when any one of currents flowing through the plurality of LED sets is still smaller than the second initial value, the accumulator 642 will keep counting to increase the analog signal VDAC of the DAC 644. Therefore, when the output voltage V_{REG, 4} goes up, the output voltage of the plurality of output terminals of the LED array goes up as well. If the feedback signal DFB keeps staying on logic signal level 0, the output voltage V_{REG, 4} will keep increasing. When any one of voltage values of the plurality of output terminals of the LED array is larger than the first initial value or when the is current value of all of the plurality of output terminals of the LED array is larger than the second initial value, the feedback signal DFB toggles to output logic signal level 1. When the feedback signal DFB toggles, the accumulator 642 stops counting and thus the output analog signal VDAC of the DAC 644 stays on the same voltage level. Meanwhile, the output voltage V_{REG, 4} stops increasing and each of the plurality of LED sets of the LED array stays on a proper driving voltage. In the driving applications of LED array, using digital type DC voltage converter having digital feedback signal input can save cost and improve efficiency compared with the conventional analog type DC voltage converter.

Besides, LED can be applied on any kinds of electronic display apparatus as light emitting source, ex. traffic signs or big-scale signage. Due to big-scale signage having more than ten thousands of LED, many of LED driving circuits connected in series are necessary to control the light emitting information of a plurality of LEDs.

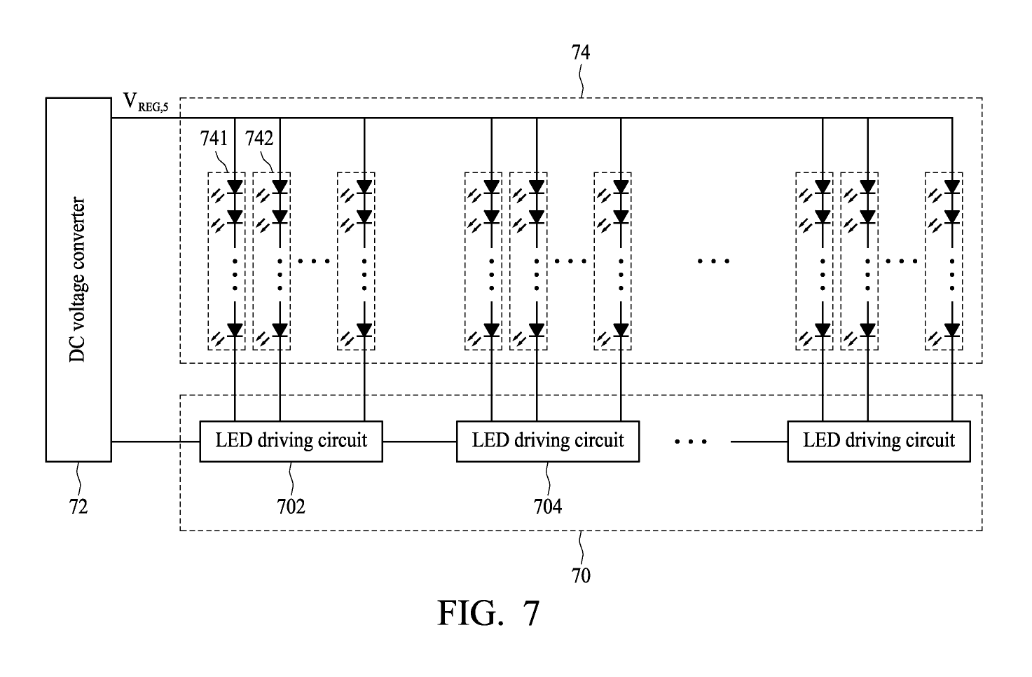

FIG. 7 schematically illustrates one embodiment of the present invention with the LED driving system 70. The LED driving system 70 is configured to control a DC voltage converter 72 to generate a regulated output voltage V_{REG, 5} to an input terminal of an LED array 74 having a plurality of LED sets 741 and 742. As shown in FIG. 7, the LED driving system includes an LED driving circuit 702 connected to the DC voltage converter 72 and an LED driving circuit 704 serially connecting to the LED driving circuit 702.

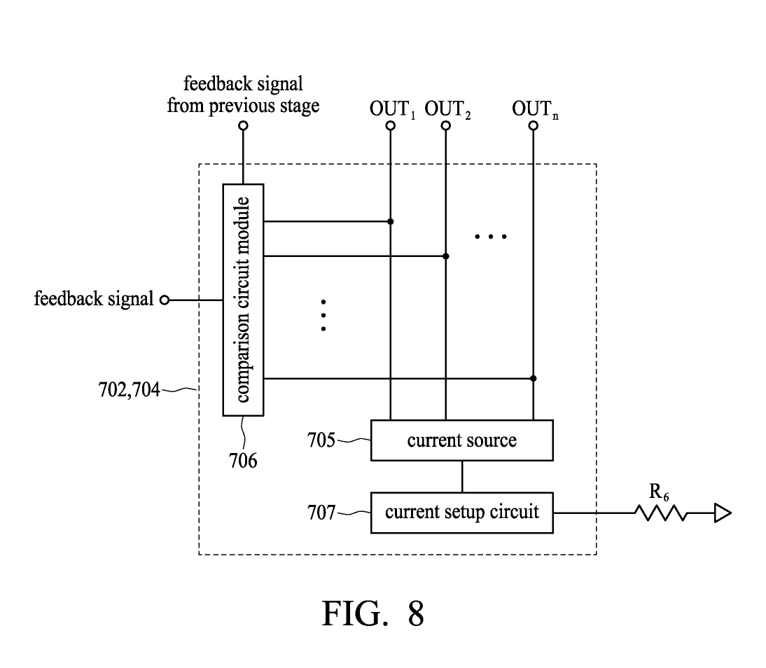

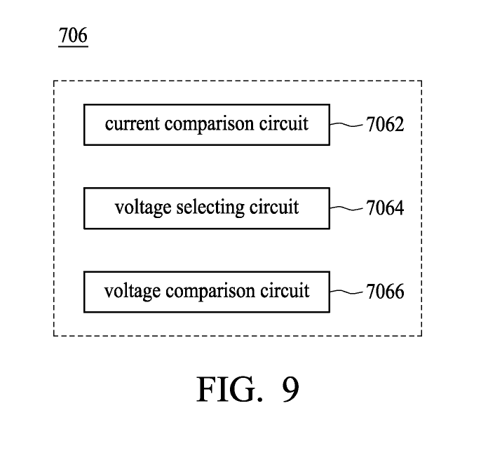

FIG. 8 shows circuit blocks of the LED driving circuit 702 and 704. Each of the LED driving circuit includes a comparison circuit module 706 and a current setup circuit 707. The comparison circuit module 706 is connected to a plurality of output terminals of the corresponding LED set of the LED array 74 and an output terminal of the previous stage. The current setup circuit 707 is to set up the current value flowing through the LED array 74 by a resistor R₆. FIG. 9 shows circuit blocks of the comparison circuit module. As shown in FIG. 9, the comparison circuit module 706 is includes a current comparison circuit 7062, a voltage selecting circuit 7064 and a voltage comparison circuit 7066. The current comparison circuit 7062 is configured to compare a current value of every corresponding LED set. The voltage selecting circuit 7064 selects voltage value of output terminal of the LED set having a minimum current value by taking into consideration output result of the current comparison circuit 7062. The current comparison circuit 7066 is configured to compare a voltage value selected by the voltage selecting circuit 7064 and a voltage value of the output terminal of the previous LED driving circuit. The feedback signal of the previous LED driving circuit generates a minimum voltage as the feedback signal or the comparison circuit module 706 can compare a voltage value of the plurality of output terminals of the corresponding LED set and a feedback signal of the previous LED driving circuit to generate a minimum voltage as a feedback signal of the current LED driving circuit.

In operation, each of the plurality of LED driving circuits of the LED driving system 70 will generate a feedback signal which represents a minimum of voltages of the plurality of input terminals of the LED driving circuit. The plurality of input terminals includes an output terminal of the previous LED driving circuit and the plurality of corresponding output terminals. Therefore, a feedback signal of the LED driving circuit 702 represents a minimum of voltages of all output terminals of the LED array 74. The feedback signal is finally transmitted to the DC voltage converter 72 to regulate output voltage V_{REG, 5}.

Similarly, the comparison circuit module 706 can include a reference voltage generating unit to generate a reference voltage. The DC voltage converter can be configured to generate a regulated output voltage V_{REG, 5} by taking into consideration a difference between the reference voltage and the feedback signal of the first LED driving circuit 702. The reference voltage can be a fixed value or regulated with current value flowing through the LED array 74.

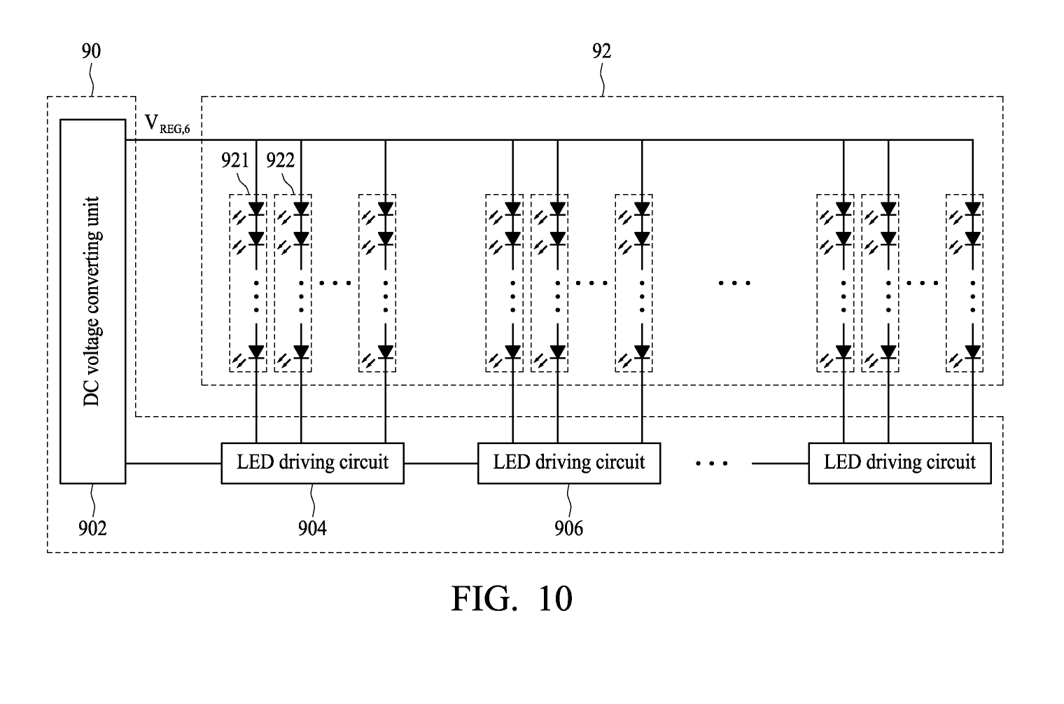

FIG. 10 schematically illustrates another embodiment of the present invention with LED driving system 90. The LED driving system 90 is configured to generate a regulated output voltage V_{REG, 6} to an input terminal of an LED array 92, wherein the LED array 92 includes a plurality of LED sets 921 and 922. As shown in FIG. 10, the LED driving system 90 includes a DC voltage converting unit 902, an LED driving circuit 904 connected to the DC voltage converting unit and an LED driving circuit 906 serially connecting to the LED driving circuit 904.

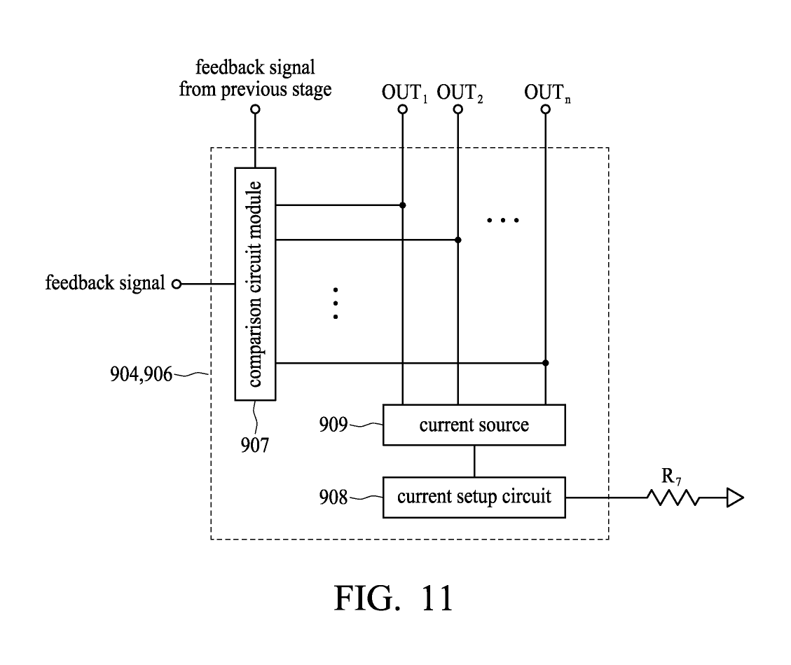

FIG. 11 shows circuit blocks of the LED driving circuit 904 and 906. Each of LED driving circuits includes a comparison circuit module 907 and a current setup circuit 908. The comparison circuit module 907 is connected to the plurality of output terminals of the corresponding LED set of the LED array 74 and an output terminal of the previous stage. The current setup circuit 908 sets up a current value flowing through the LED array 92 by a resistor R₇.

Similarly, the comparison circuit module is configured to generate a feedback signal representing a status of the LED array 92. Since each of the LED driving circuits is serially connected, a feedback signal of the LED driving circuit 904 represents a minimum of voltages of the plurality of output terminals of the LED array 92 or a minimum of currents of the plurality of LED sets of the LED array 92. The DC voltage converting unit 902 regulates the output voltage V_{REG, 6} of the driving system 90 by taking into consideration the feedback signal of the LED driving circuit 904. The comparison circuit module 904 can include a reference voltage generating unit to generate a reference voltage. Therefore, the DC voltage converting unit 902 can be configured to generate a regulated output voltage V_{REG, 6} by taking into consideration a difference between the reference voltage and the feedback signal of the LED driving circuit. The reference voltage can be regulated by different resistances.

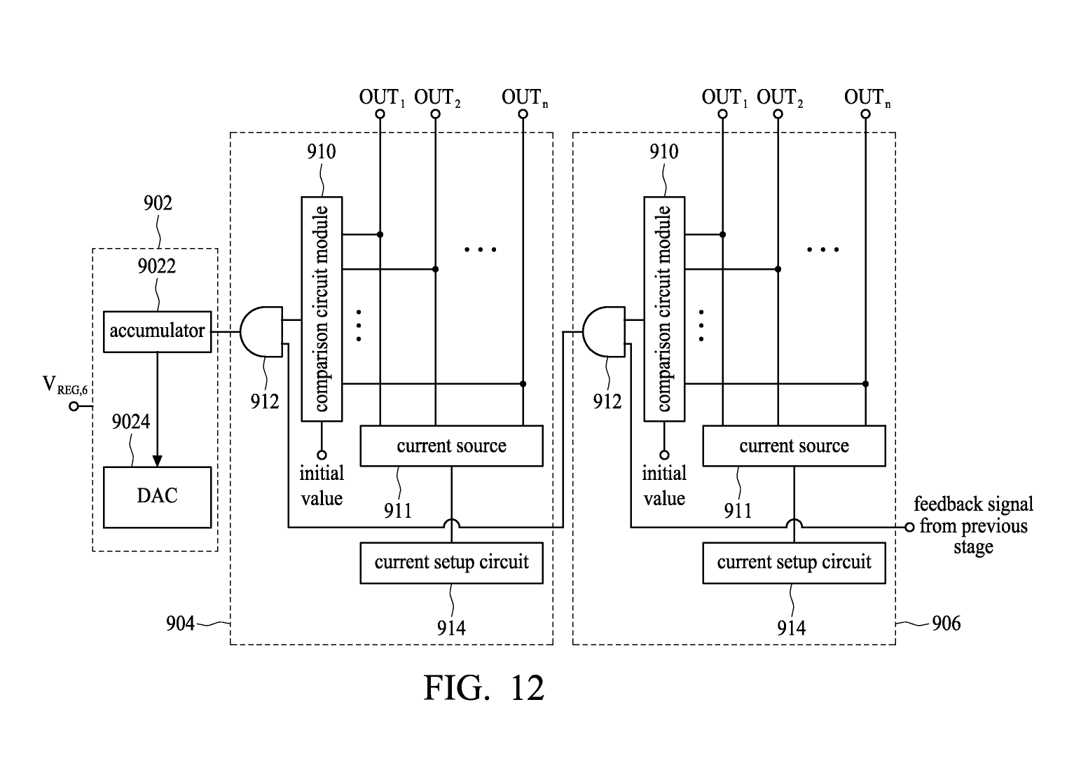

In accordance with another embodiment of the current invention, a feedback signal of the LED driving circuit 904 is a digital signal. FIG. 12 is schematically illustrates another embodiment of the present invention indicating the LED driving system 90. As shown in FIG. 12, each of the LED driving circuits includes a comparison circuit module 910, a logic circuit 912 and a current setup circuit 914. The DC voltage converting unit 902 includes an accumulator 9022 and a DAC 9044.

In accordance with one embodiment of the present invention, the comparison circuit module 910 is a voltage comparison circuit. In LED driving circuit 904, the comparison circuit module 910 compares voltages of the plurality of output terminals of the corresponding LED sets. When any one of the voltages of the plurality of output terminals is smaller than the first initial value, the logic circuit 912, such as an AND gate, will output logic signal level 0, which means any one of the voltages of the plurality of output terminals of the LED array 92 is smaller than the first initial value. The accumulator 9022 keeps counting and then an analog signal outputted by the DAC 9024 increases to increase output a voltage V_{REG, 6} of the DC voltage converting unit 902.

When all of the voltage values of the plurality of output terminals of the LED array 92 are larger than the first initial value, the logic circuit 912 of the LED driving circuit 904 will toggle to output logic signal level 1. When the logic circuit 912 toggles, the accumulator 9022 stops counting, the output voltage V_{REG, 6} of the DC voltage converting unit 902 stays on a proper voltage level to drive the LED array 92.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or both.

Moreover, the scope of the present application is not intended to be limited to the particular embodiments of the process, machine, manufacture, composition of matter, means, methods and steps described in the is specification. As one of ordinary skill in the art will readily appreciate from the disclosure of the present invention, processes, machines, manufacture, compositions of matter, means, methods, or steps, presently existing or later to be developed, which perform substantially the same function or achieve substantially the same result as the corresponding embodiments described herein may be utilized by taking into consideration the present invention. Accordingly, the appended claims are intended to include within their scope such processes, machines, manufacture, compositions of matter, means, methods, or steps.

What is claimed is:

1. A light emitting diode (LED) driving circuit for controlling a voltage converter to apply a regulated output voltage to an input terminal of an LED array having a plurality of LED sets, the LED driving circuit comprising:
a plurality of current sources connected to a plurality of output terminals of the LED array and configured to provide a current flowing through the plurality of LED sets;
a comparison circuit connected to the plurality of output terminals and configured to generate a feedback signal representing a status of the LED array; and
a current setup circuit configured to set an initial current value of the plurality of current sources;
wherein the voltage converter is configured to generate the regulated output voltage by taking into consideration the feedback signal.

2. The LED driving circuit of claim 1, wherein the comparison circuit is a voltage comparison circuit configured to compare voltage values of the plurality of output terminals of the LED array, and the feedback signal is a minimum of the voltage values of the plurality of output terminals.

3. The LED driving circuit of claim 1, wherein the comparison circuit is a current comparison circuit configured to compare a value of the current flowing through each of the plurality of LED sets.

4. The LED driving circuit of claim 1, wherein the voltage converter is configured to receive the feedback signal and an external reference voltage, and generate the regulated output voltage by taking into consideration a voltage difference between the feedback signal and the external reference voltage.

5. The LED driving circuit of claim 1, further comprising a reference voltage generating unit configured to generate a reference voltage, wherein the voltage converter is configured to receive the reference voltage and the feedback signal, and generate the regulated output voltage by taking into consideration by taking into consideration a voltage difference between the feedback signal and the reference voltage.

6. The LED driving circuit of claim 5, wherein the reference voltage is a fixed value.

7. The LED driving circuit of claim 5, wherein the current setup circuit generates a setting value by taking into consideration a current value of the plurality of current sources, and the reference voltage is proportional to the setting value.

8. A driving system for driving a light emitting diode (LED) array having a plurality of LED sets, the driving system being configured to is generate a regulated output voltage to an input terminal of the LED array, the driving system comprising:
an LED driving circuit comprising:
a plurality of current sources connected to a plurality of output terminals of the LED array and configured to provide a current flowing through the plurality of LED sets;
a comparison circuit connected to the plurality of output terminals and configured to generate a feedback signal representing a status of the LED array; and
a voltage converting unit configured to generate the regulated output voltage of the driving system by taking into consideration the feedback signal.

9. The driving system of claim 8, wherein the voltage converting unit is configured to receive the feedback signal and an external reference voltage, and generate the regulated output voltage by taking into consideration a voltage difference between the feedback signal and the external reference voltage.

10. The driving system of claim 8, wherein the voltage converting unit further comprises a reference voltage generating unit configured to generate a reference voltage, the voltage converting unit is configured to receive the feedback signal and generate the regulated output voltage by taking into consideration voltage difference between the reference voltage and the feedback signal.

11. The driving system of claim 10, wherein the current setup circuit sets an initial current value of the plurality of current sources by a first resistor, and the reference voltage generating unit sets the reference voltage by a second resistor.

12. The driving system of the claim 11, wherein the first resistor and the second resistance have the same resistance.

13. The driving system of claim 8, wherein the comparison circuit is a voltage comparison circuit configured to compare voltages of the plurality of output terminals of the LED array, and the feedback signal is a minimum of the voltages of the plurality of output terminals.

14. The driving system of claim 8, wherein the comparison circuit is a current comparison circuit configured to compare a value of the current flowing through each of the plurality of LED sets, and the feedback signal is a voltage value of one of the output terminals of the plurality of LED sets having a minimum current value.

15. The driving system of claim 8, wherein the comparison circuit is a voltage comparison circuit configured to compare a first initial value and a voltage of the plurality of output terminals of the LED array, and the feedback signal stays on a first logic signal so that the regulated output voltage of the driving system keeps increasing when any one of the voltages of the plurality of output terminals is smaller than the first initial value.

16. The driving system of claim 15, wherein the voltage converting unit further comprises:
a first accumulator configured to count the first logic signal from the LED driving circuit; and
a first DAC (Digital Analog Converter) connected to the first accumulator, and the first DAC being configured to convert an output signal of the first accumulator to a first analog signal to generate the regulated output voltage of the driving system.

17. The driving system of claim 8, wherein the comparison circuit is a current comparison circuit configured to compare a second initial value and a current flowing through each of the plurality of LED sets, and the feedback signal stays on a second logic signal so that the regulated output is voltage of the driving system keeps increasing when any one of the currents of the plurality of output terminals is smaller than the second initial value.

18. The driving system of claim 17, wherein the voltage converting unit further comprises:
a second accumulator configured to count the second logic signal from the LED driving circuit; and
a second DAC connected to the second accumulator, and the second DAC being configured to convert an output signal of the second accumulator to a second analog signal to generate the regulated output voltage of the driving system.

19. A light emitting diode (LED) driving system for controlling a voltage converter to apply an regulated output voltage to an input terminal of an LED array having a plurality of LED sets, wherein the LED driving system comprises a first LED driving circuit connected to the voltage converter and at least one second LED driving circuit connected in series to the first LED driving circuit, and each of the first and second LED driving circuits comprises:
a plurality of current sources connected to a plurality of output terminals of a corresponding LED sets of the LED driving array and configured to provide a current flowing through the corresponding LED sets;
a comparison circuit module connected to the plurality of output terminals of the corresponding LED sets of the LED driving array and an output terminal of a previous stage, and configured to generate a feedback signal representing a status of the LED array; and
a current setup circuit configured to set an initial current value flowing through the plurality of corresponding LED sets;
wherein the voltage converter is configured to generate the is regulated output voltage by taking into consideration the feedback signal of the first LED driving circuit.

20. The LED driving system of claim 19, wherein the comparison circuit module comprises a first voltage comparison circuit configured to compare a voltage of the plurality of output terminals of the corresponding LED sets and the feedback signal of the previous stage to generate a minimum voltage value as a current feedback signal of the LED driving circuit.

21. The LED driving system of claim 19, wherein the comparison circuit module comprises:
a current comparison circuit configured to compare a current value flowing through each one of the LED sets;
a voltage selecting circuit configured to select a voltage value of an output terminal of the LED set having the minimum current value by taking into consideration an output of the current comparison circuit; and
a second voltage comparison circuit configured to compare the voltage value selected by the voltage selecting circuit and the feedback signal of the previous stage to generate a minimum voltage value as a current feedback signal of the LED driving circuit.

22. The LED driving system of claim 19, wherein the voltage converter is configured to receive the feedback signal of the first LED driving circuit and an external reference voltage, and generate the regulated output voltage by taking into consideration the difference between the feedback signal and the external reference voltage.

23. The LED driving system of claim 19, wherein each of the LED driving circuit further comprises a reference voltage generating unit configured to generate a reference voltage, the voltage converter is to generate the regulated output voltage by taking into consideration a is difference between the reference voltage and the feedback signal of the first LED driving circuit.

24. The LED driving system of claim 23, wherein the reference voltage is a fixed value.

25. The LED driving system of claim 23, wherein the current setup circuit is configured to generate a setting value by taking into consideration the current value of the plurality of current sources, and the reference voltage is proportional to the setting value.

26. A light emitting diode (LED) driving system for generating a regulated output voltage to an input terminal of an LED array having a plurality of LED sets, wherein the LED driving system comprises a voltage converting unit, a first LED driving circuit connected to the voltage converting unit and at least one second LED driving circuits connected in series to the first LED driving circuit, wherein each of the first and second LED driving circuits comprises:
a plurality of current sources connected to a plurality of output terminals of a corresponding LED set of the LED driving array and configured to provide a current flowing through the corresponding LED sets;
a comparison circuit module connected to the plurality of output terminals of the corresponding LED sets of the LED driving array and an output terminal of a previous stage, and configured to generate a feedback signal representing a status of the LED array; and
a current setup circuit configured to set an initial current value flowing through the plurality of corresponding LED sets;
wherein the voltage converter is configured to generate the regulated output voltage by taking into consideration the feedback signal of the first LED driving circuit.

27. The LED driving system of claim 26, wherein the comparison is circuit module comprises a first voltage comparison circuit configured to compare a voltage of the plurality of output terminals of the corresponding LED sets and a voltage of the output terminal of the previous stage to generate a minimum voltage value as a current feedback signal of the LED driving circuit.

28. The LED driving system of claim 26, wherein the comparison circuit module comprises:
a current comparison circuit configured to compare a current value flowing through each of the plurality of LED sets;
a voltage selecting circuit configured to select a voltage value of the plurality of output terminals of the LED set having the minimum current value; and
a second voltage comparison circuit configured to compare the voltage value selected by the voltage selecting circuit and the voltage value of the output terminal of the previous stage to generate a minimum voltage value as a current feedback signal of the LED driving circuit in current stage.

29. The LED driving system of claim 26, wherein the voltage converting unit receives the feedback signal and an external reference voltage, and generates the regulated output voltage by taking into consideration a difference between the feedback signal and the external reference voltage.

30. The LED driving system of claim 26, wherein the voltage converting unit further comprises a reference voltage generating unit configured to generate a reference voltage, the voltage converting unit receives the feedback signal of the first LED driving circuit and generate the regulated output voltage by taking into consideration a difference between the reference voltage and the feedback signal.

31. The LED driving system of claim 30, wherein the current setup circuit of the LED driving circuit is configured to set an initial current value of the plurality of current sources by a first resistor and the reference voltage generating unit of the voltage converting unit is configured to set the reference voltage by a second resistor.

32. The LED driving system of claim 31, wherein the first resistor and the second resistor have the same resistance.

33. The LED driving system of claim 26, wherein each of the driving circuits further comprises a first logic circuit, the comparison circuit of each of the driving circuits is a voltage comparison circuit configured to compare the voltage of the plurality of output terminals of the LED array and a first initial value, and the feedback signal of the LED driving circuit stays on a first logic signal so that the regulated output voltage of the driving system keeps increasing when any one of the voltages of the plurality of output terminals is smaller than the first initial value, and the feedback signal of the previous stage is the first logic signal.

34. The LED driving system of claim 33, wherein the voltage converting unit further comprises:
a first accumulator configured to count the first logic signal from the first LED driving circuit; and
a first DAC connected to the first accumulator and configured to convert an output signal of the first accumulator to a first analog signal to generate the regulated output voltage of the driving system.

35. The LED driving system of claim 26, wherein each of the LED driving circuits further comprises a first logic circuit, the comparison circuit is a current comparison circuit configured to compare the current of each of the plurality LED sets and a second initial value, and the feedback signal of the LED driving circuit stays on a second logic signal so that the regulated output voltage of the driving system keeps increasing when any one of the currents of the plurality of output terminals is smaller than the second initial value and the feedback signal of the previous stage is the second logic signal.

36. The LED driving system of claim 35, wherein the voltage converting unit further comprises:
a second accumulator configured to count the second logic signal from the first LED driving circuit; and
a second DAC connected to the second accumulator and configured to convert an output signal of the second accumulator to a second analog signal to generate the regulated output voltage of the driving system.
